(19) United States
(12) Patent Application Publication
(10) Pub. No.: US 2005/0163332 A1
(43) Pub. Date: Jul. 28, 2005

(54) Luminescence speaker unit

(76) Inventor: Bear Hsiung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/761,283

(22) Filed: Jan. 22, 2004

(51) Int. Cl. H04R 9/06; H04R 25/00; H04R 11/02

(52) U.S. Cl. 381/172; 381/423; 381/426

(57) ABSTRACT

A luminescence audio unit structure includes a holder, a vibrating membrane, a membrane tray and an electro luminescence piece; wherein an expanding opening is formed in front of the holder, a magnetic element and a voice coil are set in back of the holder; the voice coil is covered by the vibrating membrane, and the internal diameter of the membrane tray is adhered to the voice coil; the electro luminescence piece is stuck on the vibrating membrane and connected to the voice coil. Inputting audio frequency to the voice coil will oscillate the vibration membrane and the membrane tray. Therefore, sound wave is produced and the electro luminescence piece will radiate light with changes of the audio frequency.

### BACKGROUND OF THE INVENTION

1. Field of the Invention

The present invention is a speaker unit, especially relates to a speaker unit of audio set with luminescence effect.

2. Description of Related Art

The quality of daily life is promoted, and people gradually put attention on music and release their pressure by listening music. Many kinds of audio devices are used in different fields. FIG. 1 shows the basic structure of a speaker unit in audio set; and it mainly includes a holder 71, a vibrating diaphragm 79 and a diaphragm tray 81; wherein an expanding opening 73 is formed in front of the holder 71, a magnetic element 75 and a voice coil 77 are set in back of the holder 71, the voice coil 77 is covered by the vibrating membrane 79, the membrane tray 81 is set inside the expanding opening 73 and the internal face of the membrane tray 81 is adhered to the voice coil 77. The sounding principle of the speaker unit is to input a signal with audio frequency to the voice coil 77 and the voice coil 77 will be moved back and forth in the magnetic element 75. The movement of the voice coil 77 will oscillate the vibrating membrane 79 and the membrane tray 81. Therefore, sound wave is produced.

Prior art speaker unit of audio set attracts consumers' interest by acoustic effects instead of visual effects. Light effects can attract consumers most. The luminescence devices become more and more attractive for visual and display function. Light emitted by luminescence devices is directly transformed from electrical energy without involving temperature rise. Moreover, the luminescence devices other features like compact size, uniform light, flexibility, no violet radiation, low power consumption, shock-proof and moisture-proof.

FIG. 2A shows the response curve of the audio frequency in the range of 50 Hz˜20 kHz, and the human's hearing is most sensitive to the frequency band of 1.2 kHz˜1.4 kHz; hence, the response curve of the audio device is within this frequency range. FIG. 2B depicts a response curve of an electro luminescence device; better illumination can be obtained within the frequency range centered at 1 kHz. However, there is not any audio device combined with the electro luminescence in prior arts.

### SUMMARY OF THE INVENTION

The present invention is to provide a luminescence audio unit structure with luminescence effects.

To achieve the above-mentioned objects, the present invention provides a luminescence audio unit structure comprising: a holder, a vibrating membrane, a membrane tray and a electro luminescence piece; wherein an expanding opening is formed in front of the holder and a magnetic element and a voice coil are set in back of the holder; the voice coil is covered by the vibrating membrane; the membrane tray is set inside the expanding opening and the internal diameter of the membrane tray is adhered to the voice coil; the electro luminescence piece is stuck to the vibrating membrane and connected to the voice coil. Audio frequency can be input to the voice coil to activate the electro luminescence piece to radiate light.

To achieve the above-mentioned objects, the present invention provides a luminescence audio unit structure comprising: a holder, a vibrating membrane, a membrane tray and an electro luminescence piece; wherein an expanding opening is formed in front of the holder and a magnetic element and a voice coil are set in back of the holder; the voice coil is covered by the vibrating membrane; the membrane tray is set inside the expanding opening and the internal diameter of the membrane tray is adhered to the voice coil; the electro luminescence piece is stuck to the membrane tray and connected to the voice coil. Audio frequency can be input to the voice coil to activate the electro luminescence piece to radiate light.

Furthermore, to achieve the above-mentioned objects, the present invention provides another luminescence audio unit structure comprising: a holder, a vibrating membrane, a membrane tray, a binding coil, a plane vibrating membrane and a electro luminescence piece; wherein an expanding opening is formed in front of the holder and a magnetic element and a voice coil are set in back of the holder; the voice coil is covered by the vibrating membrane; the membrane tray is set inside the expanding opening and the internal diameter of the membrane tray is adhered to the voice coil; the binding coil is surrounded the holder; the plane vibrating membrane is connected to the binding coil; the electro luminescence piece is stuck to the plane vibrating membrane and connected to the voice coil. Audio frequency can be input to the voice coil to activate the electro luminescence piece to radiate light.

The various objects and advantages of the present invention will be more readily understood from the following detailed description when read in conjunction with the appended drawing, in which:

### BRIEF DESCRIPTION OF THE DRAWINGS

FIG. 1 depicts an exploded view of a prior art audio unit;

FIG. 2A shows a response curve of a prior art audio unit;

FIG. 2B shows a response curve of electro luminescence;

FIG. 3 shows a perspective view of a first embodiment of the present invention;

FIG. 4 shows an exploded view of the first embodiment of the present invention;

FIG. 5 shows an exploded view of a second embodiment of the present invention;

FIG. 6 shows an exploded view of a third embodiment of the present invention; and

FIG. 7 shows an exploded view of a fourth embodiment of the present invention.

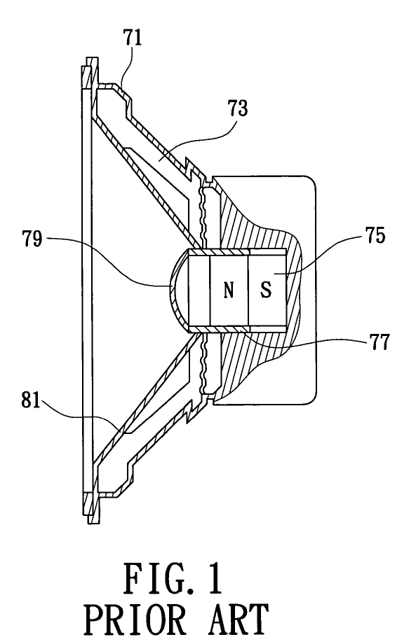

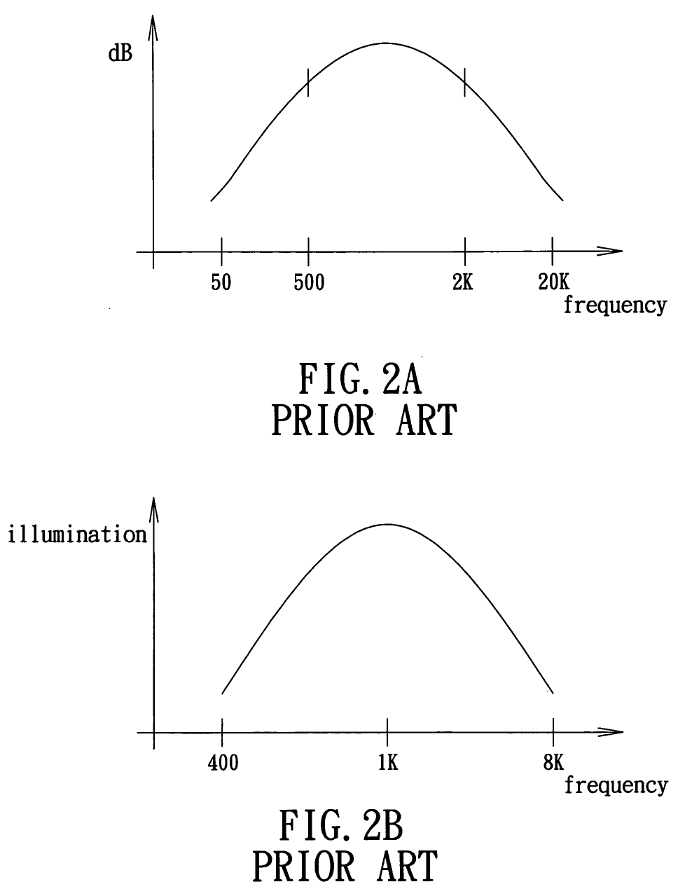

### DETAILED DESCRIPTION OF THE PREFERRED EMBODIMENTS

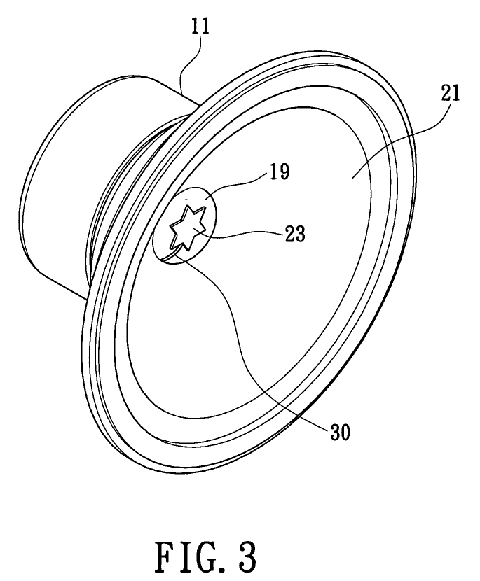

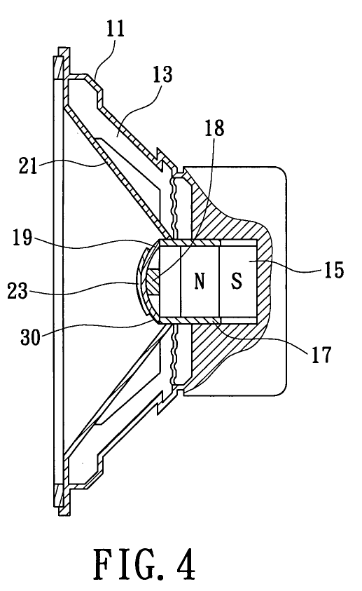

FIG. 3 and FIG. 4 depict a perspective view and a sectional view of the first embodiment of the present invention respectively. The present invention provides a luminescence speaker unit comprising: a holder 11, a vibrating membrane 19 set in an expanding opening 13, a membrane tray 21 set in the expanding opening 13 and an electro luminescence piece 23. The expanding opening 13 is formed in front of the holder 11; a magnetic element 15 and a voice coil 17 are arranged in back of the holder; the vibrating membrane 19 covers the voice coil 17; the internal face of the membrane tray 21 is adhered to the voice coil 17; a transformer 18 is arranged in the vibrating membrane 19. The electro luminescence piece 23 is stuck to the vibrating membrane 19 and connected to the voice coil 17 by a metal line 30; the transformer 18 is set between them. The appearance of the electro luminescence piece 23 can be shaped to be textual pattern or a graphic pattern. The transformer 18 has a primary coil connected to the voice coil 17 and a secondary coil is connected to the metal line 30.

The function of the transformer is to transform a signal of audio frequency obtained from the voice coil to signals for driving the electro luminescence piece 23.

The audio-frequency signal is input to the voice coil 17 to move it back and forth in the magnetic element 15, and the movement of the voice coil 17 will oscillate the vibration membrane 19 and the membrane tray 21. Therefore, sound wave is produced. Furthermore, the audio-frequency signal is transferred to the electro luminescence piece 23 through the transformer 18. Based on the fact that signal at audio frequency can drive the electro luminescence piece 23 to radiate light, the intensity of the light radiated by the electro luminescence piece 23 will be changed with the audio frequency.

The present invention will provide hearing effects as well as visual effects. The electro luminescence piece 23 is stuck on the vibrating membrane 19 and moved with the rhythm of music. With the change of the appearance of the electro luminescence piece 23, for example, the star-shaped electro luminescence piece 23, in the first embodiment will catch consumers' eyes and promote the visual effects.

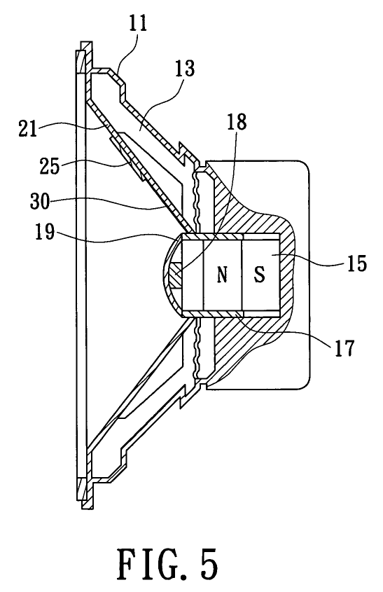

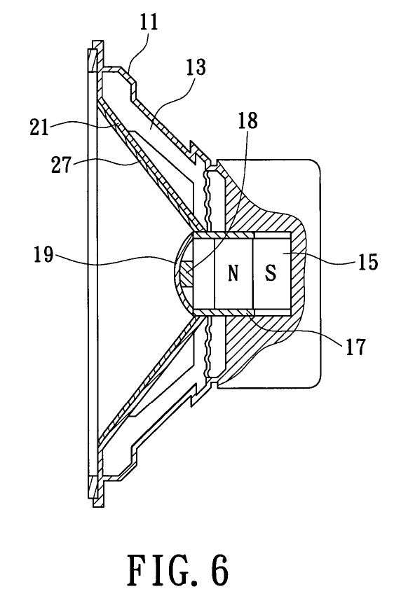

FIG. 5 depicts a sectional view of a second embodiment of the present invention. An electro luminescence piece 25 can be stuck on a part of a surface on the membrane tray 21 to make the effects mentioned in the first embodiment. An electro luminescence piece 27 can be enlarged to stuck on the overall surface of the membrane tray 21 to enhance visual effects.

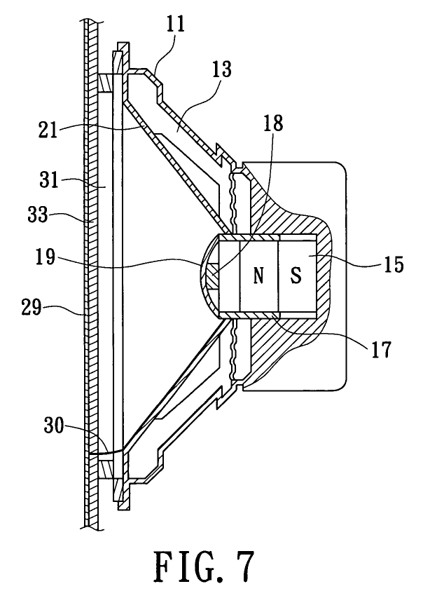

Please refer to FIG. 7, it shows a sectional view of a fourth embodiment of the present invention. A binding ring 31 is surrounded the holder 11. A plane vibrating membrane 33 is stuck on the binding coil 31 and connected with the voice coil 17 by the metal line 30; the transformer 18 is set between them. Therefore, more complex words pattern and drawings can be shown by an electro luminescence piece 29 with a lager plane membrane.

The luminescence audio unit structure of the present invention has following advantages:
(1) An electro luminescence piece can radiate light when the speaker unit gives off sound; the intensity of the light changes with the frequency of the sound.
(2) An additional driving circuit is not needed for the electro luminescence piece due to the match of response curve of the audio signal and the response curve of electro luminescence piece. A transformer is set between the electro luminescence piece and a voice coil. The electro luminescence piece can radiate light by inputting the radio frequency.
(3) The audio device outputs sounds with acoustic and visual effects; and the visual effects is changed with the audio frequency.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. A luminescence audio unit structure, comprising:
a holder, an expanding opening formed in front of the holder, a magnetic element and a voice coil set in back of the holder;
a vibrating membrane set inside the expanding opening and a voice coil covered by the vibrating membrane;
a membrane tray set inside the expanding opening, a internal diameter of the membrane tray adhered to the voice coil; and
an electro luminescence piece stuck on the vibrating membrane and connected to the voice coil.

2. A luminescence audio unit structure as in claim 1, wherein the electro luminescence piece is shaped as word patterns or drawings

3. A luminescence audio unit structure as in claim 1, further comprising a transformer connected between the electro luminescence piece and the voice coil.

4. A luminescence audio unit structure as in claim 3, wherein the transformer is set inside the vibrating membrane.

5. A luminescence audio unit structure, comprising:
a holder, an expanding opening formed in front of the holder, a magnetic element and a voice coil set in back of the holder;
a vibrating membrane set inside the expanding opening, a voice coil covered by the vibrating membrane;
a membrane tray set inside the expanding opening, a internal diameter of the membrane tray adhered to the voice coil; and
an electro luminescence piece stuck on the membrane tray and connected to the voice coil.

6. A luminescence audio unit structure as in claim 5, wherein the electro luminescence piece is shaped as word patterns or drawings.

7. A luminescence audio unit structure as in claim 5, wherein the electro luminescence piece is stuck to parts or overall surface of the membrane tray.

8. A luminescence audio unit structure as in claim 5, further comprising a transformer connected between the electro luminescence piece and the voice coil.

9. A luminescence audio unit structure as in claim 8, wherein the transformer is set inside the vibrating membrane.

10. A luminescence audio unit structure, comprising:
a holder, an expanding opening formed in front of the holder, a magnetic element and a voice coil set in back of the holder;
a vibrating membrane set inside the expanding opening, a voice coil covered by the vibrating membrane;
a membrane tray set inside the expanding opening, a internal diameter of the membrane tray adhered to the voice coil;
a binding coil surrounded the holder;
a plane vibrating membrane stuck on the binding coil; and
an electro luminescence piece stuck on the plane vibrating membrane and connected to the voice coil.

11. A luminescence audio unit structure as in claim 10, wherein the electro luminescence piece is shaped to be word patterns or drawings.

12. A luminescence audio unit structure as in claim 10, further comprising a transformer connected between the electro luminescence piece and the voice coil.

13. A luminescence audio unit structure as in claim 12, wherein the transformer is set inside the vibrating membrane.
